(19) United States
(12) Patent Application Publication
(10) Pub. No.: US 2014/0272444 A1
(43) Pub. Date: Sep. 18, 2014

(54) COLORED AND WATERPROOFED STONE USING NATURAL RAW MATERIAL, DYE SOLUTION AND WATERPROOFING

(71) Applicant: MARMORES E GRANITOS ROYAL LTDA., Rio de Janeiro (BR)

(72) Inventor: Pedro Carmo Deccache Neto, Rio de Janeiro (BR)

(21) Appl. No.: 14/011,012

(22) Filed: Aug. 27, 2013

(30) Foreign Application Priority Data
Mar. 14, 2013 (BR) 102013006117-4

(51) Int. Cl. C04B 41/52; C09K 3/18

(52) U.S. Cl. CPC C04B 41/52; C09K 3/18
USPC 428/540; 106/500; 554/1

(57) ABSTRACT

Colored and waterproofed stone using natural raw material, wherein are used pigments to impart color to the stone, plant oils to dilute the pigments and fix the color, and plant resins to waterproof the stone permanently. The pigment comprises a mineral pigment, plant pigment or chemical pigment, preferably a synthetic organic chemical pigment. The plant oils and plant resins are preferably obtained from castor, rapeseed, hemp, linseed, poppy, sesame, soybean, sunflower, palm and cotton.

The invention further relates to a waterproofing comprising a plant resin obtained from a plant oil and to a dye solution comprising a mixture of plant oils, plant resins and natural pigments.

### FIELD OF THE INVENTION

The present invention relates to stones such as marbles, granite, quartzite, onyx and calcite, which are colored and waterproofed with natural raw materials and may be used, for example, in tables, countertops, floors, coverings and decorative pieces.

### BACKGROUND OF THE INVENTION

As it is well known, there are already stones artificially colored with dye solutions of metal salts, coloring solutions from reaction of acids with metals, dye solutions resulting from chemical reactions of oxidant metals and chemical pigments, preferably synthetic organic chemical pigments.

A drawback of stones of the state of the art is the fact that the number of colors applied to the stone is very limited.

Another drawback of these stones consist in the fact that the materials used for coloring are not environmentally friendly, i.e. they are not renewable and pollute the environment.

Another drawback of these stones is that the pigments are opaque, not transparent, not bright, not reflecting the light in crystals and mask the appearance of crystalline stones.

Another drawback of these stones is that the pigments have low resistance to light, and thus the color is not permanent and will fade over time.

Another drawback is the fact that the color penetration does not reach large thicknesses.

Another drawback of the colored stones of the state of the art is the fact that they have a high porosity, which causes stains and emergence of bacteria and fungi in the pores. In the case of residential use, such as in tables, kitchen worktops and bathroom, this problem becomes particularly relevant because the stones can be stained with coffee, wine, oil, soaps and other products used in daily life and, in the case of hospital use, can transmit diseases to the users.

### SUMMARY OF THE INVENTION

The present invention aims to provide a colored stone, hydro oil-repellent, antibacterial, more compact, more resistant and translucent, using natural materials, whose penetration of the pigments with high resistance to light, which are diluted in plant oils and mixed with plant resins for waterproofing, occurs simultaneously in all thickness, permanently.

This objective is achieved through a stone colored with natural materials, using natural pigments with high resistance to the light, the pigments being mineral pigments or plaint pigments or chemical pigments to impart color to the stone, a plant oil to dilute the pigment and a plant resin to waterproof the stone, the plant resin penetrating in the pores, simultaneously filing the interstices between the crystals, and making the stone impermeable, antibacterial, more compact, more durable and permanently translucent.

The chemical pigments are preferably synthetic organic chemical pigments, which are already used for coloring stones of the prior art, but the novelty of the present invention consists in the fact that such pigments are diluted in a plant oil.

The stones have different crystal structures and components that determine its compactness, hardness and absorption. Considering that are living matter, i.e. working according to the variations of atmospheric factors, such as temperature, pressure and humidity, the use of natural materials in accordance with the present invention allows coloring and waterproofing stones such as, for example, marble, granite, quartzite, onyx, and calcite.

The pigments and dyes, diluted in plant oils and added to waterproofing plant resins, penetrate the stone together, adhering and involving the most deepest crystals in a permanent and total way, producing the molecular fusion of color and waterproofing with the crystal structures. As a final effect, they provide the obtention of a wide variety of textures and shades in the completely waterproofed stones.

The coloring of stones according to the invention can be made by any process already known, such as pressure, through heat, vacuum and immersion.

### DETAILED DESCRIPTION OF THE INVENTION

By coloring the stones according to the invention the mineral blue pigment preferably comprises ultramarine blue extracted from lapis lazuli. Another mineral pigment is the yellow ocher pigment extracted from clay. With regard to the plant pigments, the red pigment is obtained, preferably from urucum and the green pigment, preferably, from the chlorophyll of reforestation plants. With respect to the organic synthetic chemical pigments, they are preferably based on amine benzene better known as anilines. The plant and mineral pigments, as well as the organic synthetic chemical pigments, have high resistance to light and are diluted in plant oils mixed with plant resins.

From the natural pigments of the basic colors (blue, yellow, red and green), and synthetic organic chemical pigments, dissolved in plant oils and plant resins, which are extracted from plants and trees and have features of capturing, reflecting, propagating and leading the light, are obtained transparent, phosphorescent, luminous and reflective pigments of the basic colors, through which it is possible to obtain the full spectrum of colors by varying proportions and formulations.

The transparent pigments do not mask the crystalline appearance of the stones, and preserve their visual effects, such as texture, veins and nuances, giving more depth and dimension to coloring. The luminous and reflective pigments involve the stone crystals and reflect light, which is conducted by the plant resin by the same principle of the optical fiber, filling the spaces between the crystals and making the stones translucent, acquiring features of transparency. The phosphorescent pigments after exposure to sunlight, capture, absorb and store light and remain emitting light in the darkness, clearing the environment and allowing power saving during the night

The range of colors used for coloring the stones according to the invention is endless, making even possible to produce customized colors.

Plant oils used to dilute the pigment, and plant resins used for waterproofing the stone also work as fixers and stabilizers of color, and provide a high gloss finish. He plan oils are obtained from plants such as, for example, castor, rapeseed, hemp, linseed, poppy, sesame, soybean, sunflower, palm and cotton. These oils and resins are processed with performance additives such as ethanol and methanol, which are extracted, for example, from sugar cane and serve to increase the solvency power and penetration. The performance additives can be quantitatively increased or reduced, giving, respectively, the hardness and flexibility of the product to be obtained. The resins obtained from plant oils as well as the performance additives, are environmentally friendly, since they are easy to recycle and derived from renewable natural resources.

The mixture of oils, plant resins and pigments completely seals the pores, making the stone according to the invention, hydro oil-repellent, and oil stain-proof, thereby preventing the absorption of liquids, oils, and dirt. With pores completely sealed there is no formation of bacteria, fungi, molds or mites, providing the antibacterial effect to the stone, making it ideal for use in kitchens, restaurants and places requiring sterilization or complete hygiene, as in dental offices and hospitals. The waterproofing for sealing the stone plant comprises a resin obtained from a plant oil.

The pigments diluted in oil added to plant resins, have great penetrating power and enable coloring and waterproofing thickness ranging from 1 cm (one centimeter) up to 20 cm (twenty feet) in high compactness stones, such as granite, calcite and quartzite, involving the deepest crystals of the stone, penetrating into its core and filling the spaces between the crystals. With this, the stone becomes even more compact, more durable and waterproof, which improves their physical and mechanical strength, such as abrasion resistance, bending resistance and tensile strength.

As already mentioned, the materials that color and waterproof the stone according to the invention do not harm the stone, making possible its application in polished pieces, without affecting the brightness, enabling not only the coloring of plates, but also the color of decoration parts as benches, tables, tiles.

The colored stones according to the invention is ecologically correct, since it does not harm the environment, since the pigments are diluted in the plant oil and mixed with plant resins that are biodegradable. In addition, the coloring of the stones preserves the nature, as it prevents the extraction of rare stones, and make possible to reproduce them using white marble, crystallized, calcites and granites, which are materials abundant in nature.

The stones according to the invention, due to the high penetration power and involvement of large and small crystals, color fixing and catalyzing of the dye solution, can still reproduce the colors and characteristics of gems and semi-precious stones, increasing its compactness and strength, and allowing the cutting and finishing of pieces up to 3.50 m long by 2.50 m wide.

The plates or pieces made from the stones according to the invention can receive the dye solution even after being already polished, without damaging the polishing and can be worked in its thickness forming frames, fillets or any other finish, since the coloring of the stone extends throughout its thickness. This characteristic enables the re-polishing and polishing over time, remaining the stone fully colored, waterproofed antibacterial without the need of reapplication of the material nor maintenance.

Besides the advantages already mentioned, the stones according to the invention also enable the production of three-dimensional works of art with depth in the total thickness of up to 5 cm in marble, granite, quartzite calcite, with possible further demarcation regions for each color producing multicolored plates or decorative pieces with specific colors or designs and stylized as landscapes, for example. The invention also allows creating in the stone veins of other colors with pigments that are separated during catalyzing. It is also possible to customize colored designs like emblems or trademarks of companies.

In addition to the embodiments presented above, the same inventive concept can be applied to other alternatives or possibilities of use of the invention. Accordingly, the present invention should be interpreted broadly, and its scope determined by the terms of the appended claims.

1. Colored and waterproofed stone using natural raw material, wherein are used pigments to impart color to the stone, plant oils to dilute the pigments and fix the color, and plant resins to waterproof the stone permanently.

2. Stone according to claim 1, wherein the pigments are natural pigments.

3. Stone according claim 1, wherein the pigments are chemical pigments.

4. Stone according to claim 2, wherein the pigment comprises a mineral pigment.

5. Stone according to claim 2, wherein the pigment comprises a plant pigment.

6. Stone according to claim 4, wherein the blue mineral pigment is preferably ultramarine blue extracted preferably from lapis lazuli.

7. Stone according to claim 4, wherein the yellow mineral pigment is extracted preferably from clay.

8. Stone according to claim 5, wherein the red plant pigment is extracted preferably from urucum.

9. Stone according to claim 5, wherein the green plant pigment is extracted from chlorophyll.

10. Stone according to claim 1, wherein the pigment is transparent obtained from a mixture of pigments and plant oils.

11. Stone according to one of claim 1 wherein the pigment is phosphorescent obtained from a mixture of plant oils, pigments and sap of plants which have the characteristics of capture and store light.

12. Stone according to claim 1, wherein the pigment is luminous and reflective, and is obtained from a mixture of plant oils, pigments and sap of plants that present the characteristics of capturing, reflecting, conducting and propagating the light.

13. Stone according to claim 1, wherein the color extends throughout the thickness of the stone, particularly in stones with a thickness of 20 cm.

14. Stone according to claim 1, wherein the plant resin and the plant oil are obtained preferably from castor, rapeseed, hemp, linseed, poppy, sesame, soybean, sunflower, palm and cotton.

15. Stone according to claim 1, wherein it becomes translucent.

16. Stone according to claim 1, wherein the waterproofing resin extends throughout the thickness of the stone.

17. Stone according to claim 1, wherein the chemical pigments are preferably synthetic organic chemical pigments which comprise amine benzene based pigments.

18. Waterproofing for sealing a stone, wherein it comprises a plant resin obtained from a plant oil.

19. Dye solution for coloring a stone, wherein it comprises a mixture of plant oils, plant resins and natural pigments.

20. Dye solution according to claim 19, wherein it is transparent or phosphorescent.

21. Dye solution according to claim 19, wherein it is luminous.

22. Dye solution according to claim 19, wherein it is reflective.
